(19) United States
(12) Patent Application Publication
(10) Pub. No.: US 2007/0221888 A1
(43) Pub. Date: Sep. 27, 2007

(54) LIGHT EMITTING MATERIAL, LIGHT EMITTING ELEMENT, LIGHT EMITTING DEVICE AND ELECTRONIC DEVICE

(75) Inventor: Junichiro SAKATA, Atsugi (JP)

Correspondence Address: FISH & RICHARDSON P.C., P.O. BOX 1022, MINNEAPOLIS, MN, 55440-1022, US

(73) Assignee: SEMICONDUCTOR ENERGY LABORATORY CO., LTD., Atsugi-shi (JP)

(21) Appl. No.: 11/679,383

(22) Filed: Feb. 27, 2007

(30) Foreign Application Priority Data
Mar. 3, 2006 (JP) 2006-058750

(51) Int. Cl. H01B 1/12

(52) U.S. Cl. 252/500

(57) ABSTRACT

The present invention provides a light emitting material having high emission efficiency, a light emitting element which can be driven at low voltage, and a light emitting device and an electronic device with reduced power consumption. The light emitting element includes, over a substrate 100, a first electrode 101, a first insulating layer 102, a light emitting layer 103, a second insulating layer 104, and a second electrode 105, in which the light emitting layer 103 includes a light emitting element including zinc (Zn), gallium (Ga), manganese (Mn) and sulfur (S).

### TECHNICAL FIELD

The present invention relates to a light emitting material. Further, the present invention relates to light emitting devices and electronic devices having the light emitting element.

### BACKGROUND ART

In recent years, thin and flat display devices have been needed as display devices used for televisions, cellular phones, digital cameras, and the like. As the display devices satisfying this need, display devices using self-light emitting elements have attracted attention. One of the self-light emitting elements is a light emitting element utilizing electroluminescence (EL), and this light emitting element includes a light emitting material interposed between a pair of electrodes and can provide emission from the light emitting material by voltage application.

Such a self-light emitting element has advantages over a liquid crystal display element, such as high visibility of the pixels and no need of backlight, and is considered to be suitable as a flat panel display element. Another major advantage of such a light emitting element is that it can be manufactured to be thin and lightweight. In addition, extremely high response speed is also a feature.

Further, such a self-light emitting element can be formed into a film shape; therefore, plane emission can be easily obtained by forming a large-area element. Since this feature is hard to obtain from a point light source typified by an incandescent lamp or an LED or a linear light source typified by a fluorescent lamp, the self-light emitting element has high utility as a plane light source which is applicable to a lighting system or the like.

Light emitting elements utilizing electroluminescence are classified according to whether a light emitting material is an organic compound or an inorganic compound. In general, the former is referred to as an organic EL element, and the latter as an inorganic EL element.

Inorganic EL elements are classified according to their element structures into dispersion-type inorganic EL elements and thin-film inorganic EL elements. They differ in that the former includes a light emitting layer in which particles of a light emitting material are dispersed in a binder, and the latter includes a light emitting layer formed from a thin film of a light emitting material; however, they are share a common feature in that both require electrons accelerated by a high electric field. Note that a mechanism of emission includes a donor-acceptor recombination-type light emission which utilizes a donor level and an acceptor level and a localized-type light emission which utilizes inner-shell electron transition of metal ions. In general, it is often the case that dispersion-type inorganic EL elements employ donor-acceptor recombination-type light emission, and thin-film inorganic EL elements employ localized-type light emission.

Such inorganic EL elements have an advantage of having longer life than organic EL elements. However, they require electrons accelerated by a high electric field for the light emitting layer, so in general it is necessary to apply a voltage of several hundred volts to the light emitting element. For example, a high-luminance blue light emitting inorganic EL element which is necessary for a full-color display has been developed in recent years; however, it requires a drive voltage of 100 V to 200 V (for example, see Reference 1: Japanese Journal of Applied Physics, 1999, Vol. 38, pp. L1291-L1292). Therefore, inorganic EL elements consume a large amount of electric power, so it is difficult to apply them to small and medium-sized displays, for example, to displays of cellular phones or the like.

### DISCLOSURE OF INVENTION

In view of the above problem, it is an object of the present invention to provide a novel light emitting material. It is another object to provide a light emitting element which can be driven at low voltage. It is still another object to provide light emitting devices and an electronic devices with reduced power consumption.

According to an aspect of the present invention, a light emitting material includes a first material including zinc, gallium, manganese and sulfur; and a second material which is a light emission center and which includes at least one element selected from the group consisting of copper, silver, aluminum, terbium, europium, thulium, cerium, praseodymium, samarium, and erbium.

In the light emitting material having the above structure, the second material may include a halogen element.

According to an aspect of the present invention, a light emitting element includes a light emitting layer including the light emitting material having the above structure; and a pair of electrodes provided so as to sandwich the light emitting layer.

According to an aspect of the present invention, a light emitting device includes a light emitting element having the above structure and a control circuit which controls emission of the light emitting element. Note that light emitting device as referred to in this specification includes image display devices, light emitting devices, and light sources (including lighting systems). Further, the light emitting device also includes all of the following modules: a module in which a connector such as an FPC (flexible printed circuit), a TAB (tape automated bonding) tape, or a TCP (tape carrier package) is attached to a panel provided with light emitting elements; a module having a TAB tape or a TCP provided with a printed wiring board at the end thereof; and a module having an IC (Integrated Circuit) directly mounted on a light emitting device by a COG (Chip On Glass) method.

According to an aspect of the present invention, an electronic device includes a display portion which includes the light emitting element having the above structure; and a control circuit which controls emission of the light emitting element.

A light emitting material of the present invention has high emission efficiency.

In addition, a light emitting element of the present invention can be driven at low voltage.

Further, since a light emitting device and an electronic device of the present invention include a light emitting element which can be driven at low voltage, power consumption can be reduced. In addition, a driver circuit which can withstand high voltage is not necessary and thus, a light emitting device can be manufactured at low cost.

### BRIEF DESCRIPTION OF DRAWINGS

FIG. 1 shows a light emitting element according to an aspect of the present invention;

FIG. 2 shows a light emitting element according to an aspect of the present invention;

FIG. 3 shows a light emitting element according to an aspect of the present invention;

FIG. 4 shows a light emitting device according to an aspect of the present invention;

FIG. 5 shows a light emitting device according to an aspect of the present invention;

FIG. 6 shows a light emitting device according to an aspect of the present invention;

FIGS. 7A and 7B each show a light emitting device according to an aspect of the present invention;

FIG. 8 shows a light emitting device according to an aspect of the present invention;

FIGS. 9A and 9B show a light emitting device according to an aspect of the present invention;

FIGS. 10A to 10D each show an electronic device according to an aspect of the present invention;

FIG. 11 shows a lighting system according to an aspect of the present invention;

FIGS. 12A to 12C show a lighting system according to an aspect of the present invention;

FIG. 13 shows a lighting system according to an aspect of the present invention;

FIG. 14 shows a lighting system according to an aspect of the present invention;

FIG. 15 shows an electronic device according to an aspect of the present invention; and

FIG. 16 shows an electronic device according to an aspect of the present invention.

### BEST MODE FOR CARRYING OUT THE INVENTION

Hereinafter, embodiment modes of the present invention are explained in detail with reference to the accompanying drawings. However, the present invention is not limited to the following description. It will be apparent to those skilled in the art that various changes can be made to the modes and details of the present invention without departing from the spirit and the scope of the present invention. Thus, the present invention should not be interpreted as being limited to the following description of the embodiment modes.

### Embodiment Mode 1

Embodiment Mode 1 will describe a light emitting material according to the present invention.

A light emitting material of the present invention includes at least zinc (Zn), gallium (Ga), manganese (Mn), and sulfur (S).

As a formation method of the light emitting material, various methods, such as a solid-phase method or a liquid-phase method (for example, a coprecipitation method) can be used. A liquid-phase method such as a spray pyrolysis method, a double decomposition method, a method employing a pyrolytic reaction of a precursor, a reverse micelle method, a method in which one or more of the above methods and high-temperature baking are combined, or a freeze-drying method can be used.

In the solid-phase method, synthesis is conducted by a solid-phase reaction. Elements to be reacted or compounds including elements to be reacted are weighed, mixed in a mortar, and baked by being heated in an electric furnace. The baking temperature is preferably 700 to 1500° C. This is because if the temperature is too low, the solid phase reaction will not progress, while if the temperature is too high, the host material will decompose. Baking may be conducted with the mixed material in powdered form; however, it is preferable to conduct baking with the mixed material in pellet form. Compared to other methods, such as a liquid-phase method, this method requires baking to be conducted at a higher temperature. However, this method is simple, and therefore gives high productivity and is suitable for mass production.

In the liquid-phase method (for example, a coprecipitation method), elements to be reacted and compounds including an element to be reacted are reacted with each other in a solution and dried, then baked. In this method, since particles of the light emitting material are uniformly dispersed and the particles each have a small diameter, the synthesis reaction can progress at an even lower baking temperature than that of the solid-phase method.

A method for synthesizing a light emitting material of the present invention by a solid-phase method will now be described. Zinc (Zn), gallium (Ga), manganese (Mn), and sulfur (S) are each weighed and mixed such that a desired element ratio is obtained. In this case, metals or compounds of zinc (Zn), gallium (Ga), and manganese (Mn) can be used. As the compound, for example, zinc oxide (ZnO), zinc chloride (ZnCl₂), zinc fluoride (ZnF₂), zinc arsenide (Zn₃As₂), zinc phosphide (Zn₃P₂), zinc sulfide (ZnS), zinc antimonide (Zn₃Sb₂), zinc selenide (ZnSe), zinc telluride (ZnTe), gallium oxide (Ga₂O₃), gallium chloride (GaCl₃), gallium fluoride (GaF₃), gallium arsenide (GaAs), gallium nitride (GaN), gallium phosphide (GaP), gallium sulfide (Ga₂S₃), gallium selenide (Ga₂Se₃), gallium telluride (Ga₂Te₃), manganese oxide (MnO), manganese chloride (MnCl₂), manganese fluoride (MnF₂), manganese arsenide (MnAs), manganese boride (MnB), manganese phosphide (Mn₂P), manganese sulfide (MnS), manganese antimonide (MnSb), manganese silicide (MnSi), manganese selenide (MnSe), manganese telluride (MnTe), or the like can be used. Note that if elemental sulfur (S) is not used, zinc sulfide (ZnS), gallium sulfide (Ga₂S₃), or manganese sulfide (MnS) is preferably used. The mixing may be conducted by pounding a metal or a compound in a mortar, a planetary ball mill, or the like.

Next, the above mixed material is baked. Baking may be conducted after the mixed material is heated in a sealed evacuated tube. The baking may be also conducted under a sulfide gas atmosphere. As the sulfide gas, for example, hydrogen sulfide, carbon disulfide, sulfur vapor, mercaptan such as ethyl mercaptan or methyl mercaptan, dimethyl sulfur, diethyl sulfur, or the like can be used. Most preferably, hydrogen sulfide gas is used. This is because hydrogen sulfide partially decomposes and sulfur and hydrogen are generated, and thus, sulfur deficiency in the light emitting material is prevented, while at the same time, a hydrogen reduction can be anticipated. The baking temperature is preferably 700 to 1500° C. Baking is preferably conducted with the mixed material in pellet form, rather than in powdered form.

Note that the zinc (Zn), gallium (Ga), manganese (Mn), and sulfur (S) do not necessarily have to be included at the same time; however, it is preferable to conduct a process for including gallium (Ga) and manganese (Mn) at the same time.

The thus obtained light emitting material is a light emitting material having a high concentration of manganese (Mn), since gallium (Ga) increases the solid solubility of (Mn). As a result, a light emitting material having high luminous efficiency can be obtained.

In addition, a material with a light emission center may be added to the above-described light emitting material. As the material with the light emission center, either a light emitting material with a localized-type light emission center or a light emitting material with a donor-acceptor recombination-type light emission center can be used. As the light emitting material with the localized-type light emission center, for example, copper (Cu), silver (Ag), terbium (Th), europium (Eu), thulium (Tm), praseodymium (Pr), samarium (Sm), cerium (Ce), erbium (Er), or the like can be used. Note that a halogen element such as fluorine (F) or chlorine (Cl) may be added as charge compensation. Meanwhile, as a light emitting material with a donor-acceptor recombination-type light emission center, a light emitting material containing a first impurity element which forms a donor level and a second impurity element which forms an acceptor level can be used. As the first impurity element, for example, fluorine (F), chlorine (Cl), aluminum (Al), or the like can be used. As the second impurity element, for example, copper (Cu), silver (Ag), or the like can be used.

When adding such a material with a light emission center, a metal or a compound of the metal can be used. As the compound, for example, copper sulfide (Cu₂S), copper chloride (CuCl), copper fluoride (CuF), silver sulfide (Ag₂S), silver chloride (AgCl), silver fluoride (AgF), terbium chloride (TbCl₃), terbium fluoride (TbF₃), europium oxide (Eu₂O₃), europium chloride (EuCl₃), europium fluoride (EuF₃), thulium oxide (Tm₂O₃), thulium fluoride (TmF₃), praseodymium chloride (PrCl₃), praseodymium fluoride (PrF₃), samarium oxide (Sm₂O₃), samarium chloride (SmCl₃), samarium fluoride (SmF₃), cerium oxide (CeO₂), cerium chloride (CeCl₃), cerium fluoride (CeF₃), erbium oxide (Er₂O₃), erbium chloride (ErCl₃), erbium fluoride (ErF₃), or the like can be used.

When synthesizing a light emitting material to which a material with a light emission center described above, for example, terbium (Tb) is added, baking may be conducted using a zinc compound or the like to which a material with a light emission center has been added in advance. For example, zinc sulfide (ZnS) to which terbium (Th) or the like is added, gallium sulfide (Ga₂S₃), and manganese sulfide (MnS) are mixed and baked. Alternatively, a material with a light emission center may be mixed with the other elements, zinc (Zn), gallium (Ga), manganese (Mn), and sulfur (S), then baking conducted. For example, zinc sulfide (ZnS), gallium sulfide (Ga₂S₃), manganese sulfide (MnS), and terbium fluoride (TbF₃) are mixed and baked. Further alternatively, a material with a light emission center may be added after baking has been conducted, then baking may be conducted again. For example, zinc sulfide (ZnS), gallium sulfide (Ga₂S₃) and manganese sulfide (MnS) are mixed and baked, then terbium fluoride (TbF₃) is added thereto and baked again.

Note that the concentration of the material with the light emission center such as terbium (Th) may be 0.01 to 10 atomic %, and is preferably in the range of 0.05 to 5 atomic %.

This embodiment mode can be combined with any of the other embodiment modes as appropriate.

### Embodiment Mode 2

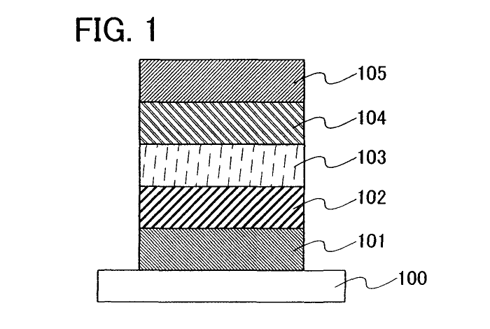

Embodiment Mode 2 will describe a thin-film type light emitting element according to the present invention with reference to FIG. 1.

The light emitting element described in this embodiment mode has an element structure including, over a substrate 100, a first electrode 101 and a second electrode 105, a first insulating layer 102 and a second insulating layer 104 in contact with the electrodes, and a light emitting layer 103 between the first insulating layer 102 and the second insulating layer 104. The light emitting element described in this embodiment mode emits light from the light emitting layer 103 by voltage application between the first electrode 101 and the second electrode 105 and can be operated by either DC drive or AC drive.

The substrate 100 is used as a support of the light emitting element. For the substrate 100, glass, plastic, or the like can be used, for example. Note that another material may be used as long as it functions as a support of the light emitting element during a manufacturing process of the light emitting element.

The first electrode 101 and the second electrode 105 can be formed using a metal, an alloy, a conductive compound, a mixture thereof, or the like. Note that it is necessary that one or both of the first electrode 101 and the second electrode 102 are transparent in order to obtain plane emission. Specifically, an example of the transparent electrode is indium tin oxide (ITO), indium tin oxide containing silicon or silicon oxide (ITSO), indium zinc oxide (IZO), indium oxide containing tungsten oxide and zinc oxide (IWZO), or the like. Films including these conductive metal oxides are generally formed by sputtering. For example, a film of indium zinc oxide (IZO) can be formed by sputtering using a target in which 1 wt % to 20 wt % zinc oxide is added to indium oxide. A film of indium oxide containing tungsten oxide and zinc oxide (IWZO) can be formed by sputtering using a target containing 0.5 wt % to 5 wt % tungsten oxide and 0.1 wt % to 1 wt % zinc oxide with respect to indium oxide. Alternatively, aluminum (Al), silver (Ag), gold (Au), platinum (Pt), nickel (Ni), tungsten (W), titanium (Ti), chromium (Cr), molybdenum (Mo), iron (Fe), cobalt (Co), copper (Cu), palladium (Pd), or a nitride of a metal material (for example, titanium nitride (TiN)) can be used as a metal electrode. Note that in the case where the metal electrode is formed to have a light transmitting property, a material with low visible light transmittance can also be used as a light transmitting electrode when formed with a thickness of approximately 1 nm to 50 nm, and is preferably approximately 5 nm to 20 nm. Note that the electrode can be formed by vacuum evaporation, CVD, or a sol-gel method other than sputtering.

The light emitting layer 103 is a layer including the light emitting material described in Embodiment Mode 1, which can be formed by a vacuum evaporation method such as a resistance heating evaporation method or an electron beam (EB) evaporation method, a sputtering method, a metal organic CVD method or a low-pressure hydride transport CVD method, an atomic layer epitaxy (ALE) method, or the like. Although there is no particular limitation on the thickness, it is preferably in the range of 10 nm to 1000 nm.

There are no particular limitations on the first insulating layer 102 and the second insulating layer 104, but they preferably have high dielectric strength and dense film quality. Furthermore, they preferably have a high dielectric constant. For example, a film of yttrium oxide (Y₂O₃), titanium oxide (TiO₂), aluminum oxide (Al₂O₃), hafnium oxide (HfO₂), tantalum oxide (Ta₂O₅), silicon oxide (SiO₂), barium titanate (BaTiO₃), strontium titanate (SrTiO₃), lead titanate (PbTiO₃), silicon nitride (Si₃N₄), zirconium oxide (ZrO₂), or the like, a mixed film thereof, or a stacked film of two or more kinds can be used. These insulating films can be formed by sputtering, evaporation, CVD, or the like. Although there is no particular limitation on the thickness, it is preferably in the range of 10 nm to 1000 nm. In the case of low voltage driving, the light emitting element preferably has a thickness of 500 nm or less, and is more preferably 100 nm or less.

Since a light emitting material having high emission efficiency is used in the light emitting element of the present invention, a light emitting element which can be driven at low voltage can be obtained. Further, the light emitting material can emit light at a low driving voltage, and thus, a light emitting element with low power consumption can be provided.

This embodiment mode can be combined with any of the other embodiment modes as appropriate.

### Embodiment Mode 3

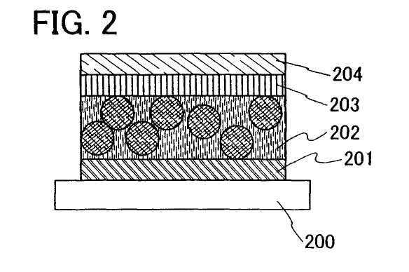

Embodiment Mode 3 will describe a dispersion type light emitting element according to the present invention with reference to FIG. 2.

The light emitting element shown in this embodiment mode has an element structure in which a first electrode 201, a second electrode 204, an insulating layer 203 in contact with the second electrode, and a light emitting layer 202 between the first electrode 201 and the insulating layer 203 are provided over a substrate 200. The light emitting element described in this embodiment mode emits light from the light emitting layer 202 by voltage application between the first electrode 201 and the second electrode 204 and can be operated by either DC drive or AC drive.

The light emitting layer 202 is a film in which particles of the light emitting material shown in Embodiment Mode 1 are dispersed in a binder. The binder is a substance used for fixing the particles of the light emitting material in a dispersed state and for keeping a shape as a light emitting layer. The light emitting material is evenly dispersed and fixed in the light emitting layer by the binder. In the case where particles having a desired size cannot be obtained depending on a manufacturing method of the light emitting material, the light emitting material is pounded in a mortar so as to form particles having a desired size.

As a formation method of the light emitting layer, a droplet-discharging method which can selectively a light emitting layer, a printing method such as screen printing or offset printing, a coating method such as spin coating, a dipping method, a dispenser method or the like can be used. There are no particular limitations on the film thickness; however, a film thickness in the range of 10 to 1000 nm is preferable. In the light emitting layer including the light emitting material and the binder, the ratio of the light emitting material is preferable greater than or equal to 50 wt % and less than or equal to 80 wt %.

As the binder used in this embodiment mode, an organic material or an inorganic material can be used, and further, a mixed material of an organic material and an inorganic material can be used. As an organic material, the following resin material can be used: a polymer having a comparatively high dielectric constant such as a cyanoethyl cellulose based resin, polyethylene, polypropylene, a polystyrene based resin, a silicone resin, an epoxy resin, vinylidene fluoride, or the like. In addition, a heat-resistant high-molecular material such as aromatic polyamide or polybenzimidazole, or a siloxane resin may also be used. The siloxane resin is a resin including a Si—O—Si bond. Further, the following resin material may also be used: a vinyl resin such as polyvinyl alcohol or polyvinylbutyral, a phenol resin, a novolac resin, an acrylic resin, a melamine resin, a urethane resin, an oxazole resin (polybenzoxazole), or the like. On the other hand, the inorganic material contained in the binder can be formed with a material of silicon oxide (SiOₓ), silicone nitride (SiNₓ), silicon containing oxygen and nitrogen, aluminum nitride (AlN), aluminum containing oxygen and nitrogen or aluminum oxide (Al₂O₃), titanium oxide (TiO₂), BaTiO₃, SrTiO₃, lead titanate (PbTiO₃), potassium niobate (KNbO₃), lead niobate (PbNbO₃), tantalum oxide (Ta₂O₅), barium tantalate (BaTa₂O₆), lithium tantalate (LiTaO₃), yttrium oxide (Y₂O₃), zirconium oxide (ZrO₂), ZnS and other substances containing an inorganic insulating material. By mixing an organic material with an inorganic material having a high dielectric constant (by adding or the like), a dielectric constant of an electroluminescent layer including a light emitting material and a binder can be further controlled and the dielectric constant can be further increased.

In the formation process of the light emitting layer 202, the light emitting material is dispersed in a solution including a binder. As a solvent for the solution containing a binder that can be used in this embodiment mode, a solvent capable of forming a solution having a viscosity such that it can dissolve a binder material and is suitable for a method for forming a light emitting layer (various wet processes) and a desired film thickness, may be appropriately selected. An organic solvent or the like can be used, and when, for example, a siloxane resin is used as a binder, propylene glycol monomethyl ether, propylene glycol monomethyl ether acetate (also referred to as PGMEA), 3-methoxy-3-methyl-1-butanol (also referred to as MMB), or the like can be used as the organic solvent.

There is no particular limitation on the insulating layer 203 in FIG. 2; however, the insulating layer 203 preferably has a high dielectric strength, dense film quality, and further, a high dielectric constant. For example, yttrium oxide (Y₂O₃), titanium oxide (TiO₂), aluminum oxide (Al₂O₃), hafnium oxide (HfO₂), tantalum oxide (Ta₂O₅), barium titanate (BaTiO₃), strontium titanate (SrTiO₃), lead titanate (PbTiO₃), silicon nitride (Si₃N₄), zirconium oxide (ZrO₂), silicon oxide (SiO₂), or the like, a mixed film thereof, or a stacked film containing two or more kinds of the above materials can be used. These insulating films can be formed by sputtering, evaporation, CVD, or the like. In addition, particles of these insulating materials may be dispersed in a binder to form the insulating layer 203. The binder material for forming the insulating layer can be formed by using the same materials and methods as those of the binder contained in the light emitting layer. There is no particular limitation on the film thickness, but it is preferably in the range of 10 to 1000 nm.

Since a light emitting material having high emission efficiency is used in the light emitting element of the present invention, a light emitting element which can be driven at low voltage can be obtained. Further, the light emitting material can emit light at a low driving voltage, and thus, a light emitting element with low power consumption can be provided.

This embodiment mode can be combined with any of the other embodiment modes as appropriate.

### Embodiment Mode 4

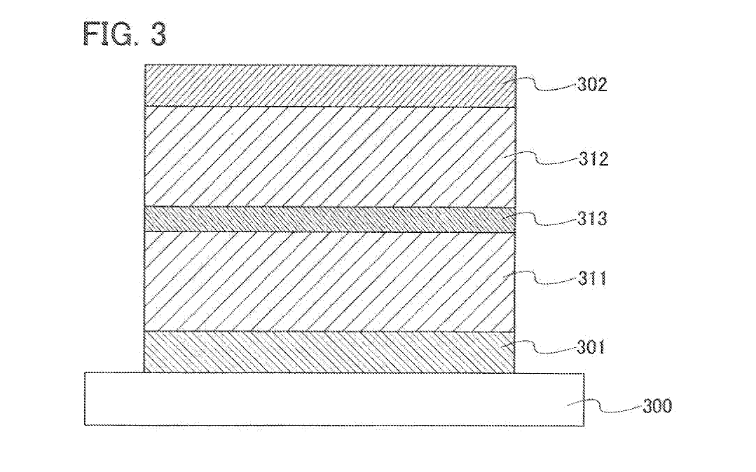

Embodiment Mode 4 will describe a mode of a light emitting element with a structure in which a plurality of light emitting units of the present invention are stacked (hereinafter referred to as a stacked element) with reference to FIG. 3. This light emitting element has a plurality of light emitting units between a first electrode and a second electrode.

In FIG. 3, a first light emitting unit 311 and a second light emitting unit 312 are stacked between a first electrode 301 and a second electrode 302 over a substrate 300. Materials similar to those in Embodiment Modes 2 and 3 can be applied to the first electrode 301 and the second electrode 302. Furthermore, the first light emitting unit 311 and the second light emitting unit 312 have the same structure, which is similar to the structures described in Embodiment Modes 2 and 3.

A charge generation layer 313 contains a complex of an organic compound and a metal oxide. The complex of an organic compound and a metal oxide is formed from an organic compound and a metal oxide such as V₂O₅, MoO₃, or WO₃. As the organic compound, various compounds such as an aromatic amine compound, a carbazole derivative, aromatic hydrocarbon, and a high molecular compound (oligomer, dendrimer, polymer, or the like) can be used. It is to be noted that the organic compound having hole mobility of 10⁻⁶ cm²/Vs or higher is preferably used as a hole transporting organic compound. However, other than the above materials may be used as long as the material has a higher hole transporting property than an electron transporting property. Since the complex of an organic compound and a metal oxide is excellent in carrier injecting property and carrier transporting property, it can realize low voltage drive and low current drive.

The charge generation layer 313 may be formed using a combination of the complex of an organic compound and a metal oxide, with another material. For example, a layer containing the complex of an organic compound and a metal oxide, and a layer containing a compound selected from electron donating materials and a compound having a high electron transporting property may be combined to form the charge generation layer 313. Alternatively, a layer containing the complex of an organic compound and a metal oxide, and a transparent conductive film may be combined to form the charge generation layer 313.

In any case, it is preferable that the charge generation layer 313 interposed between the first light emitting unit 311 and the second light emitting unit 312 injects electrons to the light emitting unit on one side and injects holes to the light emitting unit on the other side when a voltage is applied to the first electrode 301 and the second electrode 302.

Although the light emitting element having two light emitting units is described in this embodiment mode, a light emitting element in which three or more light emitting units are stacked can also be employed. Arrangement of a plurality of light emitting units, which are partitioned by an electrically insulating charge generation layer between a pair of electrodes, as in the light emitting element of this embodiment mode, can realize an element having the long life in a high luminance region, while keeping a current density low. In addition, in the case where the light emitting element is applied to a lighting system, for example, uniform emission in a large area is possible because voltage drop due to resistance of an electrode material can be suppressed. Furthermore, in the case where the light emitting element is applied to a display device, a display device with a high contrast which can be driven at a low voltage and consumes less power can be realized.

This embodiment mode can be combined with any of the other embodiment modes as appropriate.

### Embodiment Mode 5

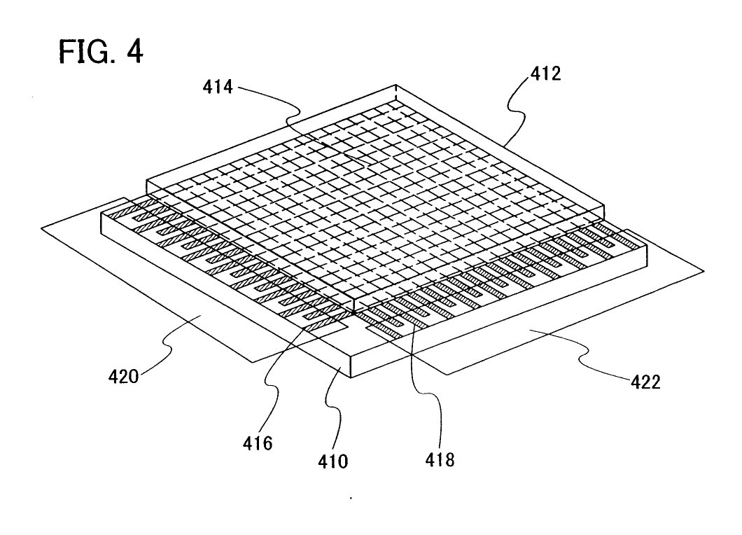

Embodiment Mode 5 will describe a display device as one mode of the light emitting device with reference to FIGS. 4 to 8.

FIG. 4 is a schematic configuration diagram showing a main part of the display device. Over a substrate 410, a first electrode 416 and a second electrode 418 that extends in a direction intersecting with the first electrode 416 are provided. A light emitting layer similar to those described in Embodiment Modes 1 and 2 is provided at least at the intersection portion of the first electrode 416 and the second electrode 418, and thus, a light emitting element is formed. In a light emitting device of FIG. 4, a plurality of first electrodes 416 and a plurality of second electrodes 418 are disposed and light emitting elements of pixels are arranged in a matrix, thus, a display portion 414 is formed. In the display portion 414, emission and non-emission of each light emitting element are controlled by controlling potentials of the first electrode 416 and the second electrode 418. In this manner, the display portion 414 can display moving images and still images.

In this light emitting device, a signal for displaying an image is applied to each of the first electrode 416 extending in one direction over the substrate 410 and the second electrode 418 that intersects with the first electrode 416, and thus, emission or non-emission of a light emitting element is selected. In other words, this is a simple matrix display device of which pixels are driven solely by a signal given from an external circuit. A display device like this has a simple structure and can be manufactured easily even when the area is enlarged.

In the above, when the first electrode 416 is formed from aluminum, titanium, tantalum or the like, and the second electrode 418 is formed from indium oxide, indium tin oxide (ITO), indium zinc oxide, or zinc oxide, a display device having the display portion 414 on the counter substrate 412 side can be obtained. In this case, when a thin oxide film is formed over a surface of the first electrode 416, a barrier layer is formed and luminous efficiency can be improved because of a carrier blocking effect. When the first electrode 416 is formed from indium oxide, indium tin oxide (ITO), indium zinc oxide, or zinc oxide, and the second electrode 418 is formed from aluminum, titanium, tantalum or the like, a display device having the display portion 414 on the substrate 410 side can be provided. Furthermore, when both the first electrode 416 and the second electrode 418 are formed from transparent electrodes, a dual emission display device can be provided.

A counter substrate 412 may be provided as necessary, and it can serve as a protective member when provided adjusting to the position of the display portion 414. Even if a hard plate member is used, a resin film or a resin material can be applied instead. The first electrode 416 and the second electrode 418 are led to end portions of the substrate 410 to form terminals to be connected to external circuits. In other words, the first electrode 416 and the second electrode 418 are in contract with flexible wiring boards 420 and 422 at the end portions of the substrate 410. As the external circuits, there are a power supply circuit, a tuner circuit, and the like, in addition to a controller circuit that controls a video signal.

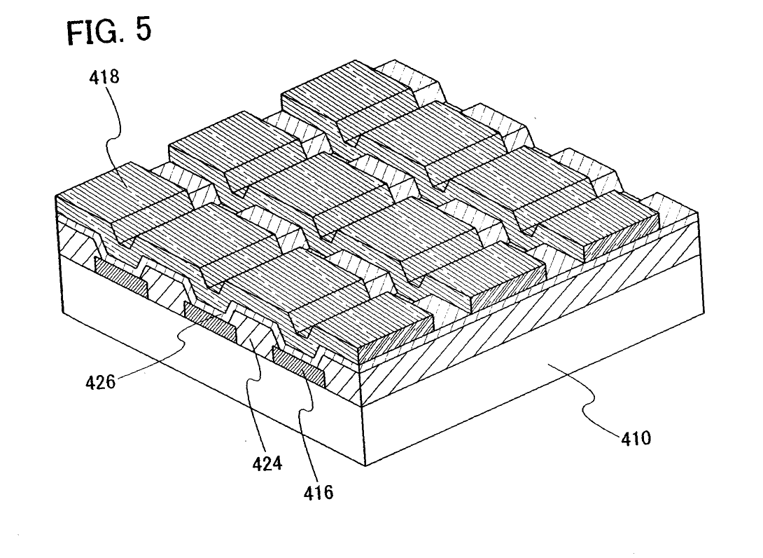

FIG. 5 is a partial enlarged view showing a structure of the display portion 414. A partition layer 424 is formed on a side end portion of the first electrode 416 formed over the substrate 410. An EL layer 426 is formed at least over an exposed surface of the first electrode 416. The second electrode 418 is formed over the EL layer 426. The second electrode 418 intersects with the first electrode 416, so that it extends over the partition layer 424 as well. The partition layer 424 is formed using an insulating material so that a short circuit between the first electrode 416 and the second electrode 418 does not occur. In a portion where the partition layer 424 covers the end portion of the first electrode 416, a side end portion of the partition layer 424 is sloped so as not to form a steep step, such that it has a so-called tapered shape. When the partition layer 424 has such a shape, coverage of the EL layer 426 and the second electrode 418 improves, and defects such as cracks or tear can be prevented.

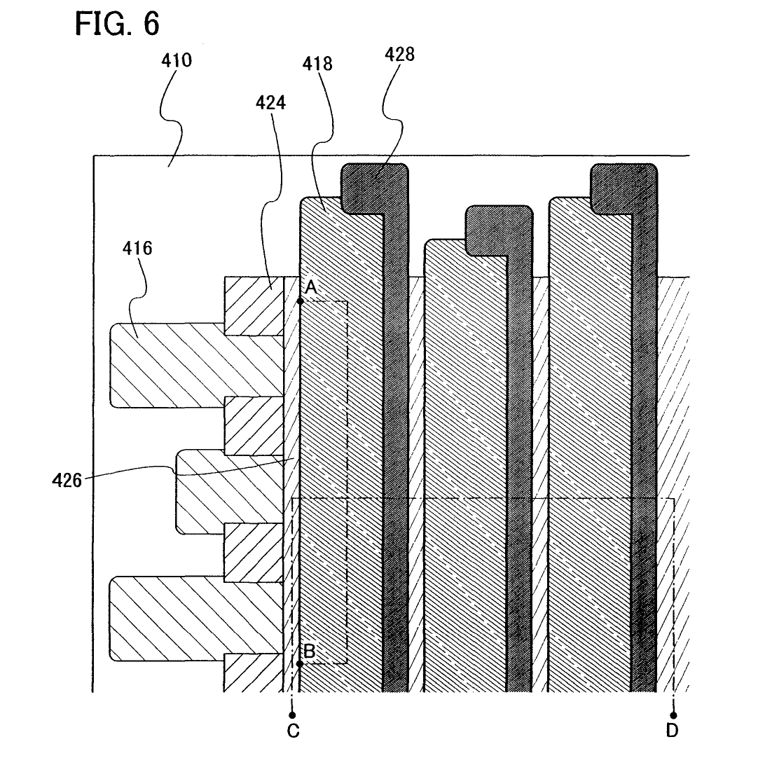

FIG. 6 is a plane view of the display portion 414, which shows the arrangement of the first electrode 416, the second electrode 418, the partition layer 424, and the EL layer 426. In the case where the second electrode 418 is formed of a transparent conductive film of an oxide such as indium tin oxide or zinc oxide, an auxiliary electrode 428 is preferably provided so as to reduce the resistance loss. In this case, the auxiliary electrode 428 may be formed using a refractory metal such as titanium, tungsten, chromium, or tantalum, or a combination of the refractory metal and a low resistance metal such as aluminum or silver.

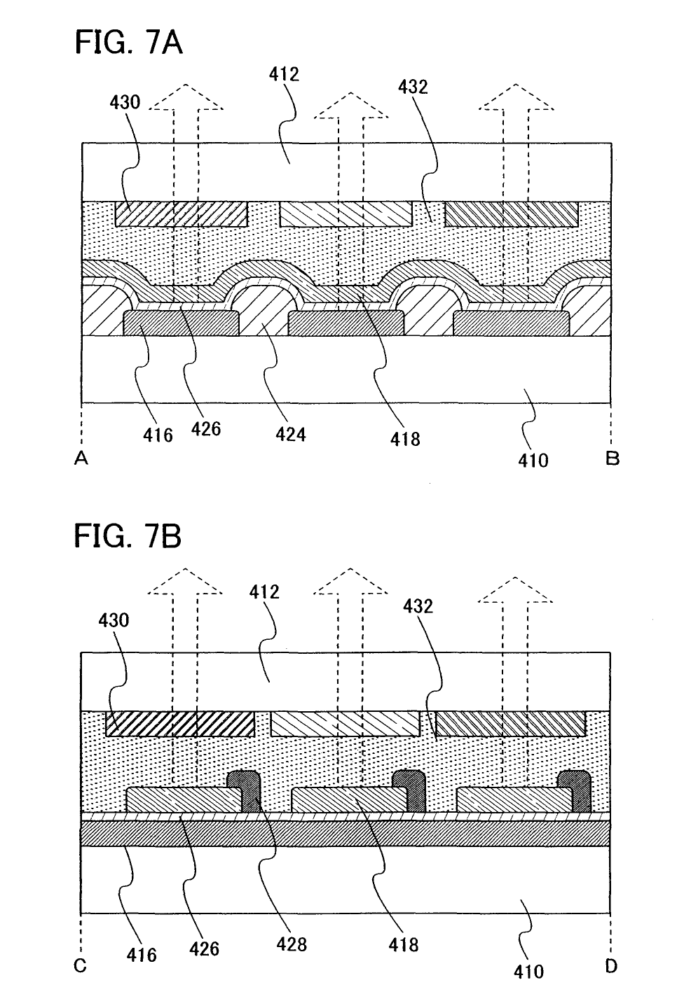

FIGS. 7A and 7B show cross-sectional views taken along the line A-B and the line C-D in FIG. 6, respectively. FIG. 7A is a cross-sectional view in which the first electrodes 416 are lined up, and FIG. 7B is a cross-sectional view in which the second electrodes 418 are lined up. The EL layer 426 is formed at the intersection portions of the first electrode 416 and the second electrode 418, and light emitting elements are formed in these portions. The auxiliary electrode 428 shown in FIG. 7B is provided over the partition layer 424 and in contact with the second electrode 418. The auxiliary electrode 428 formed over the partition layer 424 does not block light from the light emitting element formed at the intersection portion of the first electrode 416 and the second electrode 418; therefore, the emitted light can be efficiently utilized. In addition, with this structure, a short circuit between the auxiliary electrode 428 and the first electrode 416 can be prevented.

In FIGS. 7A and 7B, examples in which color conversion layers 430 are provided for the counter substrate 412 are shown. The color conversion layer 430 converts the wavelength of light emitted from the EL layer 426 so as to change the color of the emitted light. In this case, light emitted from the EL layer 426 is preferably blue light or ultraviolet light with high energy. When the color conversion layers 430 for converting light to red, green, and blue light are arranged, a display device that performs RGB full-color display can be obtained. Furthermore, the color conversion layer 430 can be replaced by a colored layer (color filter). In this case, the EL layer 426 may be made to emit white light. A filler 432 may be provided as appropriate to fix the substrate 410 and the counter substrate 412 to each other.

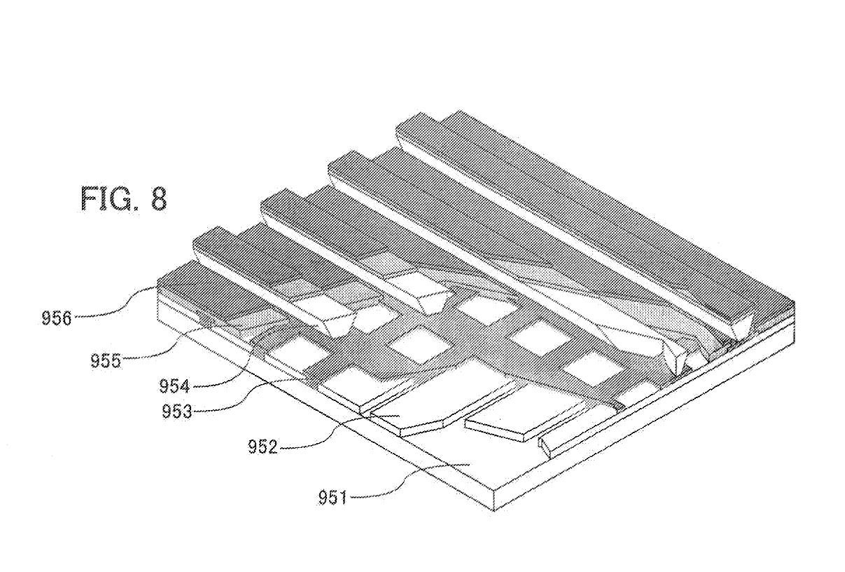

Another structure of the display portion 414 is shown in FIG. 8. In the structure shown in FIG. 8, an end portion of a first electrode 952 over a substrate 951 is covered by an insulating layer 953. In addition, a partition layer 954 is provided over the insulating layer 953. Sidewalls of the partition layer 954 have a slant such that a distance between one sidewall and the other sidewall becomes narrower as the sidewalls gets closer to the substrate surface. In other words, a cross-section taken along the direction of a shorter side of the partition layer 954 has a trapezoidal shape, and the base of the trapezoid (a side of the trapezoid that is parallel to the surface of the insulating layer 953 and is in contact with the insulating layer 953) is shorter than the upper side of the trapezoid (a side of the trapezoid that is parallel to the surface of the insulating layer 953 and is not in contact with the insulating layer 953). By providing the partition layer 954 in this manner, an EL layer 955 and a second electrode 956 can be formed in a self-aligning manner utilizing the partition layer 954.

Since the light emitting element in the display device of this embodiment mode emits light at low voltage, a booster circuit or the like is not required; therefore, the structure of the device can be simplified.

### Embodiment Mode 6

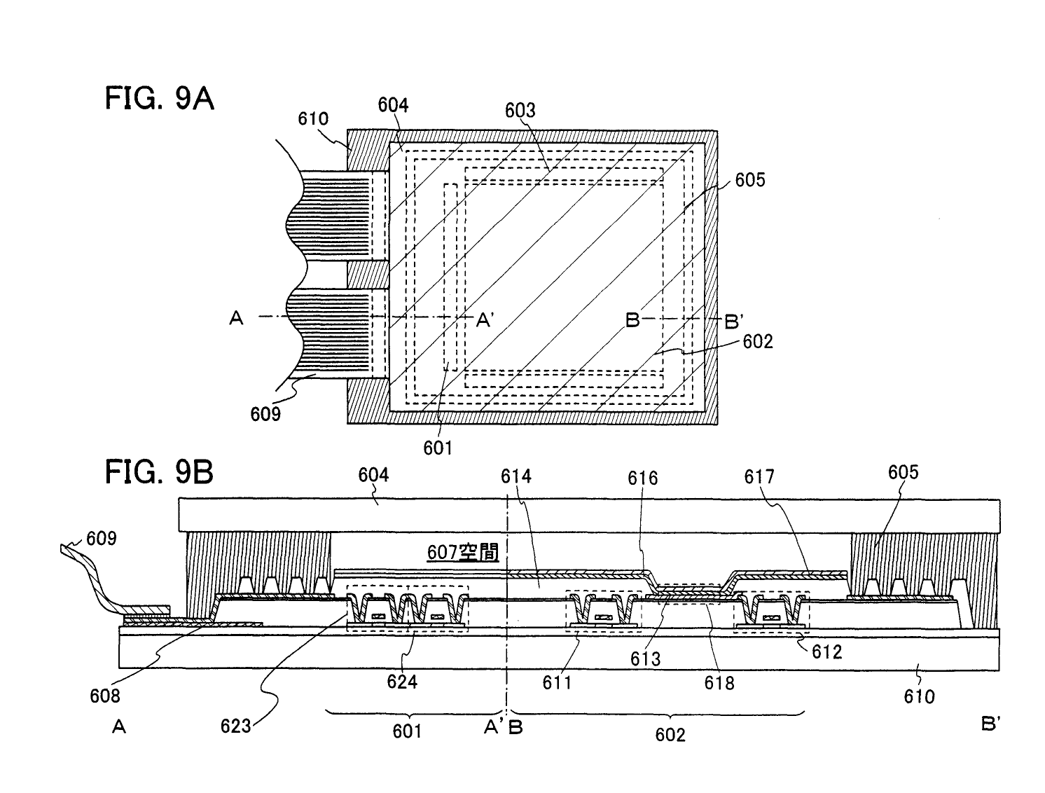

Embodiment Mode 6 will describe an active light emitting device in which the drive of a light emitting element is controlled by a transistor. In this embodiment mode, a light emitting device including the light emitting element manufactured by applying the invention in a pixel portion will be described with reference to FIGS. 9A and 9B. Note that FIG. 9A is a top view showing the light emitting device and FIG. 9B is a cross-sectional view taken along lines A-A′ and B-B′ of FIG. 9A. In FIGS. 9A and 9B, concerning the reference numerals for the areas shown by dotted lines, 601 denotes a driver circuit portion (a source side driver circuit); 602, a pixel portion; and 603, a driver circuit portion (a gate side driver circuit). Further, reference numeral 604 denotes a sealing substrate; 605, a sealant; and 607, a space surrounded by the sealant 605.

Note that a lead wiring 608 is a wiring for transmitting signals to be inputted to the source side driver circuit 601 and the gate side driver circuit 603 and receives a video signal, a clock signal, a start signal, a reset signal, or the like from an FPC (flexible printed circuit) 609 that serves as an external input terminal. Note that only the FPC is shown here; however, the FPC may be provided with a printed wiring board (PWB). The light emitting device in this specification includes not only a main body of the light emitting device but also the light emitting device with an FPC or a PWB attached.

Next, a cross-sectional structure is explained with reference to FIG. 9B. The driver circuit portion and the pixel portion are formed over an element substrate 610. Here, the source side driver circuit 601 that is the driver circuit portion and one pixel in the pixel portion 602 are shown.

Note that a CMOS circuit that is a combination of an n-channel TFT (also referred to as a thin film transistor) 623 and a p-channel TFT 624 is formed as the source side driver circuit 601. The driver circuit may be a CMOS circuit, a PMOS circuit, or an NMOS circuit. A driver-integrated type structure in which a driver circuit is formed over the same substrate is described in this embodiment mode, but the driver-integrated type structure is not necessarily required. A driver circuit can be formed external to the substrate, rather than over the substrate. Note that there is no particular restriction on the structure of the TFT. A staggered TFT or an inversely staggered TFT may be used for example. Further, there is no particular restriction on the crystallinity of a semiconductor film used in the TFT. An amorphous semiconductor film may be used, or a crystalline semiconductor film may be used. Furthermore, there is no particular restriction on a semiconductor material used. An inorganic compound may be used, or an organic compound may be used.

The pixel portion 602 includes a plurality of pixels, each of which includes a switching TFT 611, a current control TFT 612, and a first electrode 613 which is electrically connected to a drain of the current control TFT 612. Note that an insulator 614 is formed to cover an end portion of the first electrode 613. Here, a positive type photosensitive acrylic resin film is used.

The insulator 614 is formed to have a curved surface with curvature at an upper end portion or a lower end portion thereof in order to obtain favorable coverage. For example, in the case of using positive type photosensitive acrylic resin as a material of the insulator 614, the insulator 614 is preferably formed to have a curved surface with a curvature radius (0.2 μm to 3 μm) only at an upper end portion. Either a negative type which becomes insoluble in an etchant by light irradiation or a positive type which becomes soluble in an etchant by light irradiation can be used as the insulator 614.

An EL layer 616 and a second electrode 617 are formed over the first electrode 613. At least one of the first electrode 613 and the second electrode 617 has a light transmitting property, through which light emitted from the EL layer 616 can be taken out to the outside.

The EL layer 616 includes any one of the light emitting layers described in Embodiment Modes 1 to 4.

Note that the first electrode 613, the EL layer 616, and the second electrode 617 can be formed by various methods. Specifically, they can be formed by a vacuum evaporation method such as a resistance heating evaporation method or an electron beam (EB) evaporation method, a physical vapor deposition (PVD) method such as a sputtering method, a chemical vapor deposition (CVD) method such as a metal organic CVD method or a low-pressure hydride transport CVD method, an atomic layer epitaxy (ALE) method, or the like. Further, an inkjet method, a spin coating method, or the like can be used. In addition, a different film formation method may be employed to form each electrode or layer.

By attaching the sealing substrate 604 to the element substrate 610 with the sealant 605, a light emitting element 618 is provided in the space 607 surrounded by the element substrate 610, the sealing substrate 604, and the sealant 605. Note that the space 607 is filled with a filler. There are cases where the space 607 may be filled with an inert gas (such as nitrogen or argon) as such a filler, or where the space 607 may be filled with the sealant 605.

Note that an epoxy-based resin is preferably used as the sealant 605. Further, it is desirable that materials used for the sealant and the filler are materials which allow as little water and oxygen as possible to penetrate. As the sealing substrate 604, a plastic substrate formed of FRP (Fiberglass-Reinforced Plastics), PVF (polyvinyl fluoride), Mylar, polyester, acryl, or the like can be used besides a glass substrate or a quartz substrate.

As described above, the light emitting device including the light emitting element formed according to the present invention can be obtained.

The light emitting device shown in this embodiment mode includes the light emitting element described in any of Embodiment Modes 1 to 4, which can be operated with low drive voltage. Thus, a light emitting device with reduced power consumption can be obtained.

In addition, since the light emitting device shown in this embodiment mode does not require a driver circuit with high withstand voltage, manufacturing cost of the light emitting device can be reduced. In addition, reductions in weight of the light emitting device and size of a driver circuit portion can be achieved.

### Embodiment Mode 7

Embodiment Mode 7 will explain electronic devices of the present invention which includes, as a part thereof, the light emitting device described in any of Embodiment Modes 5 and 6. The electronic device shown in this embodiment mode includes the light emitting element described in any of Embodiment Modes 1 to 4. An electronic device with reduced power consumption can be provided because it includes a light emitting element with reduced drive voltage.

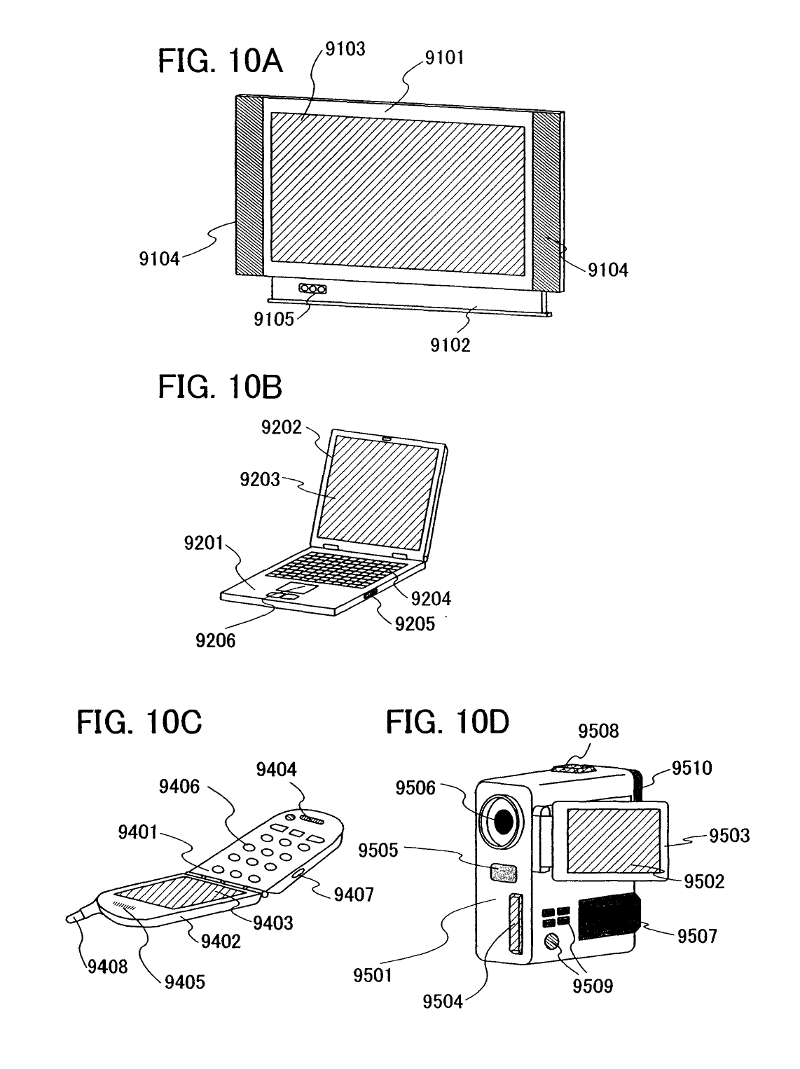

Examples of the electronic device manufactured according to the present invention are as follows: cameras such as video cameras or digital cameras, goggle type displays, navigation systems, sound reproducing devices (car audio systems, audio components, or the like), computers, game machines, portable information terminals (mobile computers, cellular phones, mobile game machines, electronic books, or the like), image reproducing devices having a recording medium (specifically, devices for reproducing a content of a recording medium such as digital versatile disc (DVD) and having a display for displaying the image), and the like. Specific examples of these electronic devices are shown in FIGS. 10A to 10D.

FIG. 10A shows a television device according to this embodiment mode, which includes a housing 9101, a support base 9102, a display portion 9103, a speaker portion 9104, a video input terminal 9105, and the like. In this television device, the display portion 9103 includes light emitting elements similar to those described in Embodiment Modes 2 to 4, that are arranged in matrix. The light emitting element has features of high luminous efficiency and low drive voltage. In addition, a short circuit due to impact from the outside, or the like can also be prevented. The display portion 9103 which includes the light emitting element also has a similar feature. Therefore, television device has less deterioration in image quality and consumes less power. With such features, a deterioration compensation circuit and a power supply circuit can be significantly reduced or downsized, thereby achieving reductions in size and weight of the housing 9101 and the support base 9102. Therefore, the housing 9101 and the support base 9102 can be made smaller and lighter. The television device of this embodiment mode has low power consumption, high image quality, and reduced size and weight. Therefore, a product which is suited to a living environment can be provided.

FIG. 10B shows a computer according to this embodiment mode, which includes a main body 9201, a housing 9202, a display portion 9203, a keyboard 9204, an external connection port 9205, a pointing mouse 9206, and the like. In this computer, the display portion 9203 includes light emitting elements similar to those described in Embodiment Modes 2 to 4, that are arranged in matrix. The light emitting element has features of high luminous efficiency and low drive voltage. In addition, a short circuit due to impact from the outside, or the like can also be prevented. The display portion 9203 which includes the light emitting element has a similar feature. Therefore, this computer has less deterioration in image quality and consumes less power consumption. With such features, a deterioration compensation circuit and a power supply circuit can be significantly reduced or downsized in the computer, thereby achieving reductions in size and weight of the main body 9201 and the housing 9202. Therefore, the main body 9201 and the housing 9202 can be made smaller and lighter. The computer of this embodiment mode has low power consumption, high image quality, and reduced size and weight, so a product which is suited to an environment can be provided. Further, a computer which is portable and has a display portion which can well withstand external impacts, such as an impact that occurs when the computer is dropped while being carried, can be provided.

FIG. 10C shows a cellular phone according to this embodiment mode, which includes a main body 9401, a housing 9402, a display portion 9403, an audio input portion 9404, an audio output portion 9405, operation keys 9406, an external connection port 9407, an antenna 9408, and the like. In this cellular phone, the display portion 9403 includes light emitting elements similar to those described in Embodiment Modes 2 to 4, that are arranged in matrix. The light emitting element has features of high luminous efficiency and low drive voltage. In addition, a short circuit due to impact from the outside, or the like can also be prevented. The display portion 9403 which includes the light emitting element also has a similar feature. Therefore, this cellular phone has less deterioration in image quality and consumes less power. With such features, a deterioration compensation circuit and a power supply circuit can be significantly reduced or downsized in the cellular phone. Therefore, the main body 9401 and the housing 9402 can be made smaller and lighter. The portable telephone of this embodiment mode has low power consumption, high image quality, and reduced size and weight, so a product which is suited to being carried can be provided. Further, a cellular phone which has a display portion which can well withstand external impacts, such as an impact that occurs when the cellular phone is dropped while being carried, can be provided.

FIG. 10D shows a camera according to this embodiment mode, which includes a main body 9501, a display portion 9502, a housing 9503, an external connection port 9504, a remote control receiving portion 9505, an image receiving portion 9506, a battery 9507, an audio input portion 9508, an operation key 9509, an eyepiece portion 9510, and the like. In this camera, the display portion 9502 includes light emitting elements similar to those described in Embodiment Modes 2 to 4, that are arranged in matrix. The light emitting element has features of high luminous efficiency, low drive voltage, and capability of preventing a short circuit due to impact from the outside, or the like. The display portion 9502 which includes the light emitting element also has similar features. Therefore, this camera has less deterioration in image quality and consumes less power. With such features, a deterioration compensation circuit and a power supply circuit can be significantly reduced or downsized in the camera. Therefore, the main body 9501 of the camera can be made smaller and lighter. The camera of this embodiment mode has low power consumption, high image quality, and reduced size and weight, so a product which is suited to being carried can be provided. Further, a camera which has a display portion which can well withstand external impacts, such as an impact that occurs when the camera is dropped while being carried, can be provided.

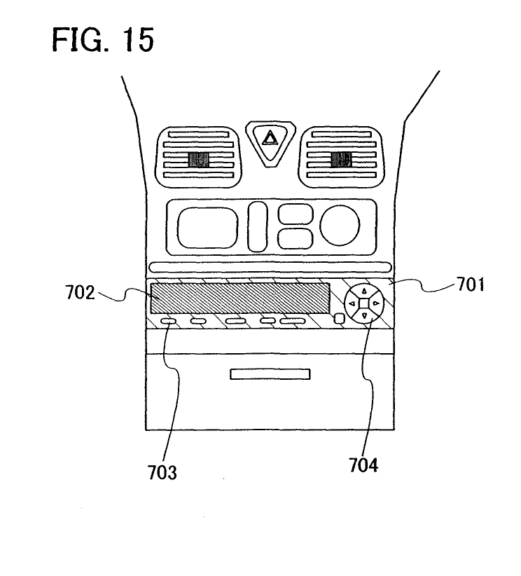

FIG. 15 shows an audio reproduction device, specifically, a car audio system. The audio reproduction device includes a main body 701, a display portion 702, and operation switches 703 and 704. The display portion 702 can be formed by the light emitting device (passive type) shown in Embodiment Mode 5 or the light emitting device (active type) shown in Embodiment Mode 6. Further, the display portion 702 may employ a segment type light emitting device. In any case, by using a light emitting material of the present invention, a display portion can be formed that is capable of bright display even when using a vehicular power source (12 to 42 V). The display portion has lower power consumption and a longer life. Further, although this embodiment mode has shown an in-car audio system, the light emitting device of the present invention may also be used in portable audio systems or audio systems for home use.

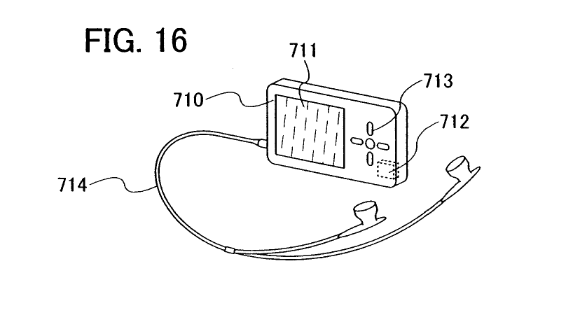

FIG. 16 shows a digital player as one example of that. The digital player shown in FIG. 16 includes a main body 710, a display portion 711, a memory portion 712, an operation portion 713, a pair of earphones 714, and the like. Note that a pair of headphones or a wireless pair of earphones can be used instead of the pair of earphones 714. The display portion 711 can be formed by the light emitting device (passive type) shown in Embodiment Mode 5 or the light emitting device (active type) shown in Embodiment Mode 6. Further, the display portion 711 may employ a segment type light emitting device. In any case, by using a light emitting material of the present invention, a display portion can be formed that is capable of bright display even when using a secondary battery (a nickel-hydrogen battery or the like). The display portion has lower power consumption and a longer life. As the memory portion 712, a hard disk or a nonvolatile memory is used. For example, a NAND type flash memory with a recording capacity of 20 to 200 gigabytes (GB) is used, and by operating the operation portion 713, an image or a sound (e.g., music) can be recorded and reproduced. In the display portions 704 and 711, white characters are displayed against a black background, and thus, power consumption can be reduced. This is particularly effective for portable audio systems.

As described above, the range of application of the light emitting device manufactured according to the present invention is very wide. The light emitting device can be applied to electronic devices in all kinds of fields. By applying the present invention, an electronic device including a display portion which consumes less power and has high reliability can be manufactured.

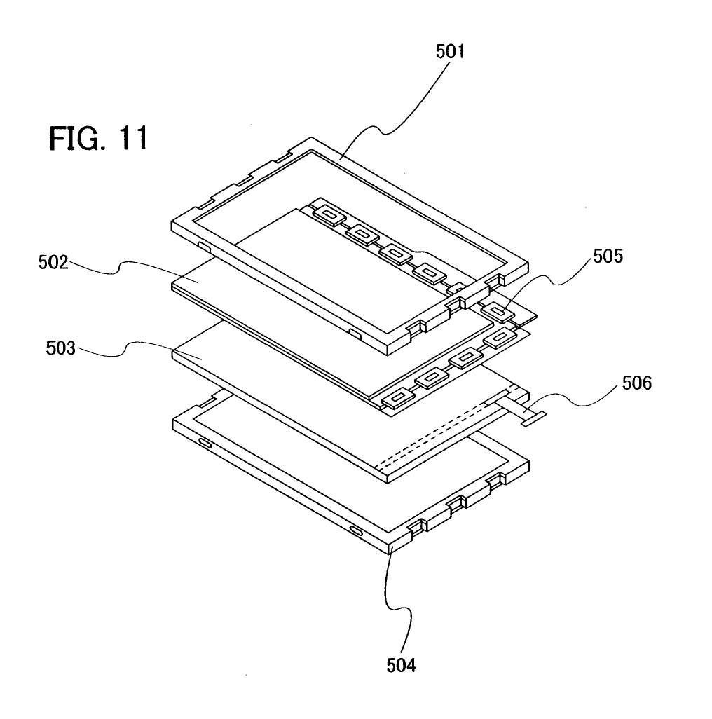

In addition, the light emitting device to which the present invention is applied can also be used as a lighting system. One mode of using the light emitting element to which the present invention is applied as a lighting system will be described with reference to FIG. 11.

FIG. 11 shows an example of a liquid crystal display device using the light emitting device to which the present invention is applied as a backlight. The liquid crystal display device shown in FIG. 11 includes a housing 501, a liquid crystal layer 502, a backlight 503, and a housing 504. The liquid crystal layer 502 is connected to a driver IC 505. The light emitting device of the present invention is used as the backlight 503, to which a voltage is supplied through a terminal 506.

By using the light emitting device of the present invention as a backlight of a liquid crystal display device, a backlight with high luminance and long life can be obtained; therefore, the quality as a display device is improved. Further, since a light emitting device of the present invention is a plane emission light emitting device and can have a large surface area, the backlight can have a large surface area, so the liquid crystal display device can also have a large surface area. Further, since the light emitting element is slim and has low power consumption, the display device can be made slimmer and can have reduced power consumption.

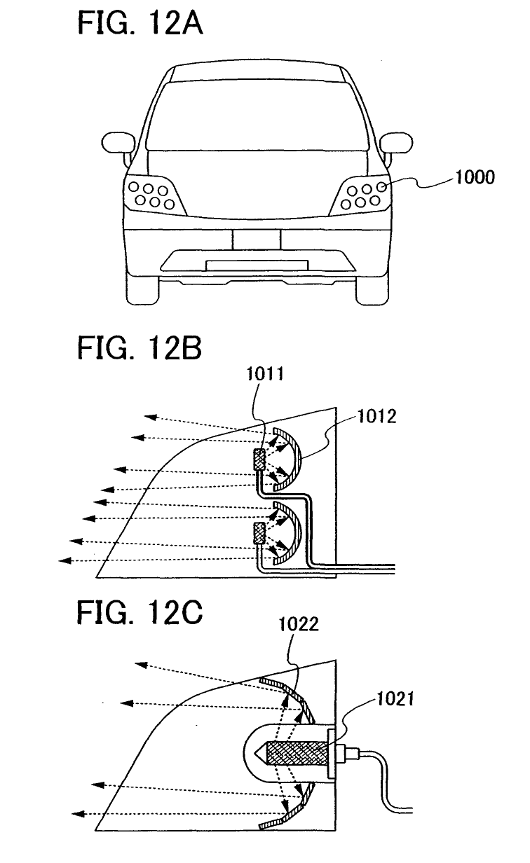

Furthermore, since a light emitting device to which the present invention is applied can emit light with high luminance, it can be used as a headlight of a car, bicycle, ship, or the like. FIGS. 12A to 12C show an example in which a light emitting device to which the present invention is applied is used as a headlight of a car. FIG. 12B is an enlarged cross-sectional view showing a headlight 1000 of FIG. 12A. In FIG. 12B, the light emitting device of the present invention is used as a light source 1011. Light emitted from the light source 1011 is reflected on a reflector 1012 and taken outside. As shown in FIG. 12B, light with higher luminance can be obtained by using a plurality of light sources. FIG. 12C is an example in which a light emitting device of the present invention that is manufactured in a cylindrical shape is used as a light source. Light emitted from the light source 1021 is reflected on a reflector 1022 and taken outside.

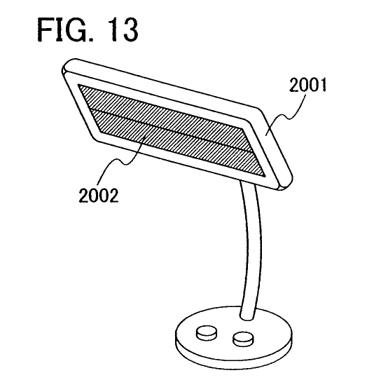

FIG. 13 shows an example in which a light emitting device to which the present invention is applied is used as a desk lamp that is one of lighting systems. The desk lamp shown in FIG. 13 includes a housing 2001 and a light source 2002, and the light emitting device of the present invention is used as the light source 2002. Since the light emitting device of the present invention can emit light with high luminance, it can brightly illuminate hands in a case such as where fine handwork is being done.

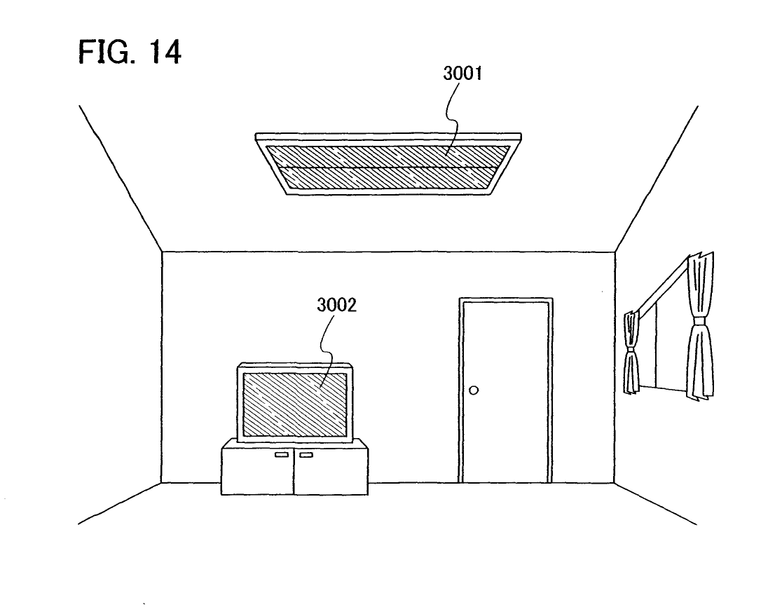

FIG. 14 shows an example in which a light emitting device to which the present invention is applied is used as an interior lighting system 3001. Since the light emitting device of the present invention can have a large area, it can be used as a large-area lighting system. In addition, since the light emitting device of the present invention is thin and consumes less power, it can be used as a thin lighting system with less power consumption. As shown in the drawing, a television device of the present invention as explained in FIG. 10A may be set in a room where the light emitting device to which the present invention is applied is used as the indoor lighting system 3001, and public broadcasting or movies can be appreciated there. In such a case, powerful images can be appreciated in a bright room while saving electricity costs, because both the lighting system and the television device 3002 consume less power.

Lighting systems are not limited to those exemplified in FIGS. 12A to 12C, 13, and 14, and the light emitting device of the present invention can be applied to lighting systems in various modes, including lighting systems for houses and public facilities. In such cases, the light emitting medium of the lighting system of the present invention is a thin film, which increases design freedom. Accordingly, various elaborately-designed products can be provided to the marketplace.

### EXAMPLE 1

Hereinafter, details of the present invention are described using Examples. Table 1 shows purity of materials which are used for synthesizing a light emitting material. The materials shown in Table 1 are all manufactured by Kojundo Chemical Lab. Co., Ltd.

TABLE 1

| material | purity | condition |
|---|---|---|
| ZnS | 99.999% | powder |
| Ga₂S₃ | 99.99% | powder |
| MnS | 99.0% | powder |
| Cu₂S | 99.0% | powder |
| Ag₂S | 99.0% | powder |

ZnS, Ga₂S₃, and MnS were each weighed such that the molar ratio of ZnS, Ga₂S₃, and MnS was 0.9:1:0.1, and stirred and mixed in an agate mortar. The mixture was put into an alumina crucible, and baked in an electric furnace which was under N₂ atmosphere for 4 hours at 1000° C. The obtained light emitting material was white. The light emitting material was excited by light at wavelengths of 254 nm and 356 nm, and red light emission was observed in both cases.

### EXAMPLE 2

ZnS, Ga₂S₃, MnS, and Cu₂S were each weighed such that the molar ratio of ZnS, Ga₂S₃, MnS, and Cu₂S was 0.9:1:0.1:0.01, then stirred and mixed in an agate mortar. The mixture was put into an alumina crucible, and baked in an electric furnace which was under N₂ atmosphere for 4 hours at 1000° C. The obtained light emitting material was yellowish white. When the light emitting material was excited by light with a wavelength of 254 nm, bluish purple light emission was observed. When the light emitting material was excited by light with a wavelength of 356 nm, red light emission was observed.

### EXAMPLE 3

ZnS, Ga₂S₃, MnS, and Ag₂S were each weighed such that the molar ratio of ZnS, Ga₂S₃, MnS, and Ag₂S was 0.9:1:0.1:0.01, then stirred and mixed in an agate mortar. The mixture was then put into an alumina crucible, and baked in an electric furnace which was under N₂ atmosphere for 4 hours at 1000° C. The obtained light emitting material was yellowish white. When the light emitting material was excited by light with a wavelength of 254 nm, bluish purple light emission was observed. When the light emitting material was excited by light with a wavelength of 356 nm, red light emission was observed.

This application is based on Japanese Patent Application serial No. 2006-058750 filed in Japan Patent Office on Mar. 3, 2006, the entire contents of which are hereby incorporated by reference.

### EXPLANATION OF REFERENCE NUMERALS

100: substrate, 101: first electrode, 102: first insulating layer, 103: light emitting layer, 104: second insulating layer, 105: second electrode, 200: substrate, 201: first electrode, 202: light emitting layer, 203: insulating layer, 204: second electrode, 300: substrate, 301: first electrode, 302: second electrode, 311: first light emitting unit, 312: second light emitting unit, 313: charge generation layer, 410: substrate, 412: counter substrate, 414: display portion, 416: first electrode, 418: second electrode, 420: flexible wiring board, 424: partition layer, 426: EL layer, 428: auxiliary electrode, 430: color conversion layer, 432: filler, 501: housing, 502: liquid crystal layer, 503: backlight, 504: housing, 505: driver IC, 506: terminal, 601: source side driver circuit, 602: pixel portion, 603: gate side driver circuit, 604: sealing substrate, 605: sealant, 607: space, 608: lead wiring, 609: FPC (flexible print circuit), 610: element substrate, 611: switching TFT, 612: current control TFT, 613: first electrode, 614: insulator, 616: EL layer, 617: second electrode, 618: light emitting element, 623: n-channel TFT, 624: p-channel TFT, 701: main body, 702: display portion, 703: operation switch, 704: display portion, 710: main body, 711: display portion, 712: memory portion, 713: operation portion, 714: earphone, 951: substrate, 952: first electrode, 953: insulating layer, 954: partition layer, 955: EL layer, 956: second electrode, 1000: headlight, 1011: light source, 1012: reflector, 1021: light source, 1022: reflector plate, 2001: housing, 2002: light source, 3001: lighting system, 3002: television device, 9101: housing, 9102: support, 9103: display portion, 9104: speaker portion, 9105: video input terminal, 9201: main body, 9202: housing, 9203: display portion, 9204: keyboard, 9205: external connection port, 9206: pointing mouse, 9401: main body, 9402: housing, 9403: display portion, 9404: audio input portion, 9405: audio output portion, 9406: operation key, 9407: external connection port, 9408: antenna, 9501: main body, 9502: display portion, 9503: housing, 9504: external connection port, 9505: remote control receiving portion, 9506: image receiving portion, 9507: battery, 9508: audio input portion, 9509: operation key, 9510: eyepiece portion.

1. A light emitting material comprising:
a first material including zinc, gallium, manganese and sulfur; and
a second material including at least one element selected from the group consisting of copper, silver, aluminum, terbium, europium, thulium, cerium, praseodymium, samarium, and erbium.

2. The light emitting material according to claim 1, wherein the second material includes a halogen element.

3. A light emitting device comprising:
a light emitting layer including a light emitting material; and
a pair of electrodes with the light emitting layer provided therebetween,
wherein the light emitting material comprises:
a first material including zinc, gallium, manganese and sulfur; and
a second material including at least one element selected from the group consisting of copper, silver, aluminum, terbium, europium, thulium, cerium, praseodymium, samarium, and erbium.

4. A light emitting device comprising:
a light emitting layer including a light emitting material;
a pair of electrodes with the light emitting layer provided therebetween; and
a control circuit which controls light emission;
wherein the light emitting material comprises:
a first material including zinc, gallium, manganese and sulfur; and
a second material including at least one element selected from the group consisting of copper, silver, aluminum, terbium, europium, thulium, cerium, praseodymium, samarium, and erbium.

5. The light emitting device according to claim 3 or 4, wherein the second material includes a halogen element.

6. The light emitting device according to claim 3 or 4 is an active type light emitting device.

7. The light emitting device according to claim 3 or 4 is a passive type light emitting device.

8. An electronic device having the light emitting device according to claim 3 or 4 in a display portion.

9. An electronic device having the light emitting device according to claim 3 or 4 is one selected from the group consisting of a camera, a television device, a goggle type display, a navigation system, a sound reproducing device, a computer, a game machine, a portable information terminal, an image reproducing devices having a recording medium, and a lighting system.
